(19) United States
(12) Patent Application Publication
(10) Pub. No.: US 2026/0034894 A1
(43) Pub. Date: Feb. 5, 2026

(54) Circuit arrangement and method for controlling and monitoring an electrical machine

(71) Applicant: SEG Automotive Germany GmbH, Stuttgart (DE)

(72) Inventors: Nima SAADAT, Stuttgart (DE); Matthias JOZWIAK, Stuttgart (DE); Johannes RAUHUT, Stuttgart (DE)

(21) Appl. No.: 19/288,204

(22) Filed: Aug. 1, 2025

(30) Foreign Application Priority Data
Aug. 2, 2024 (DE) 102024122193.3

(51) Int. Cl. B60L 15/20; H02M 1/00; H02M 7/00; H02M 7/5387

(52) U.S. Cl. CPC B60L 15/20; H02M 1/0009; H02M 7/003; H02M 7/53871; B60L 2210/42; B60L 2240/421; B60L 2240/423; B60L 2240/529

(57) ABSTRACT

The present disclosure provides a method for controlling and monitoring an electrical machine powered by a power converter. The method comprises detecting a current at at least one output of the power converter by means of at least one first current sensor having a Rogowski coil, determining a first monitoring variable for monitoring the electrical machine for partial discharges based on a first evaluation of the detected current, determining a second monitoring variable for monitoring a load current of the power converter based on a second evaluation of the detected current, and controlling the power converter using the determined first monitoring variable and the determined second monitoring variable. A computing unit and a circuit arrangement for implementing the method are also provided.

### CROSS-REFERENCE TO RELATED APPLICATIONS

This application claims priority to German Application No. 10 2024 122 193.3, filed on Aug. 2, 2024, which is hereby incorporated by reference in its entirety.

### FIELD OF INVENTION

The present disclosure relates to a circuit arrangement and a method for controlling and monitoring an electrical machine, as well as a computing unit and a computer program for carrying out the method, and an electrical drive system.

### BACKGROUND

Electric drive systems in (motor) vehicles can comprise a DC voltage source, a power converter (also called inverter) and an electrical machine (electric motor). In particular, the DC voltage source can be a so-called traction battery, which can provide voltages of up to 800 V and more. In particular, three-phase motors, e.g. permanently excited synchronous motors or asynchronous motors, can be used as the electrical machine. In order to supply the respective electrical machine with power from the DC voltage source, the power converter can, for example, be designed as a (traction) inverter and be configured to convert the direct current provided by the traction battery into a three-phase current for driving the electrical machine, for example.

Key aspects in the development and design of electric drive systems include enhancing performance and efficiency while improving reliability and functional safety, all without significantly increasing complexity and costs.

With regard to the functional safety and reliability of the electric drive system, its torque and speed (power) can be monitored, for example by means of a current measurement at one or more outputs of the power converter.

Power semiconductors with a wide bandgap (WBG) such as silicon carbide (SiC) or gallium nitride (GaN), which have a high-power density and low power losses as well as better failure and temperature behavior compared to silicon-based power semiconductors, can also be used to increase the reliability of the power converter and improve its performance and efficiency. The low power losses of WBG power semiconductors are essentially achieved by their high switching speeds. However, especially in conjunction with high battery voltages, these lead to a higher voltage stress on the insulation of the vehicle's electrical machine, which increases the probability of partial discharges occurring there.

Insulation systems of electric motors in vehicle drives are usually designed as insulation type I in accordance with IEC 60034-18-41, which must be free of partial discharges throughout its entire service life. In this context, standardized partial discharge measurements (e.g. in accordance with IEC 60270) can be carried out, for example, as an end-of-line test in production. Partial discharges on the winding insulation of an electric drive motor lead to high-frequency current pulses in its supply line(s), which can be measured using a current sensor, for example. As part of the partial discharge measurement, a partial discharge inception voltage can be determined, which represents the lowest voltage at which partial discharges occur.

However, the requirement not to allow partial discharges during the entire service life of the drive motor limits its performance and increases the required insulation thickness. It may therefore be advisable to reduce the requirement and design the insulation system as insulation type II in accordance with IEC 60034-18-41, for example, which may have partial discharges but must be protected against them.

To fulfill this requirement, partial discharges that occur during operation of the drive motor can be detected/monitored and the power converter can be controlled accordingly, for example.

In order not to significantly increase the complexity and costs of the vehicle drive, it is desirable to combine the power monitoring of the electrical machine and the detection/monitoring of partial discharges or to utilize synergies between the two monitoring systems.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The disclosure proposes a circuit arrangement and a method for controlling and monitoring an electrical machine, along with a computing unit and a computer program for implementing the method, and an electric drive system, all featuring the characteristics described in the independent patent claims.

Advantageous embodiments are the subject of the dependent claims and the following description.

The disclosure makes it possible to detect partial discharges on the electrical machine as well as monitor its power output by selectively analyzing a current sensor signal on at least one output of a power converter that feeds the electrical machine. If partial discharges are detected, a corresponding signal can be sent to the control system of the electrical machine and the control of the power converter can be adjusted accordingly.

A circuit arrangement according to the disclosure is used to control and monitor an electrical machine that is powered by a power converter. In particular, the electrical machine can be an electric motor for a (motor) vehicle (traction motor), for example an asynchronous motor or a permanently excited synchronous motor. In particular, the power converter can be a (traction) inverter, which converts, for example, a DC voltage from a vehicle battery (traction battery) into an AC voltage for driving the electrical machine. The power converter can, for example, be designed as a device with a housing that can be arranged in the vehicle between the traction motor and the traction battery.

Specifically, the power converter may include a power converter circuit with a DC side and an AC side, designed to convert current between these two sides. In particular, the power converter circuit can have a number of half bridges consisting of two series-connected switching elements, with the DC side being formed by an upper (high side) and lower (low side) connection of the half bridges and the AC side being formed by center taps of the half bridges. In particular, the switching elements can have semiconductor switches that can be opened (non-conductive) and closed (conductive) in accordance with a control signal. The semiconductor switches can comprise MOSFETs or IGBTs, in particular gallium nitride (GaN) or silicon carbide (SiC) FETs, which are operated at a high switching speed.

The DC voltage side of the power converter circuit can, for example, be connected to a DC voltage source, such as a traction battery of a vehicle, via an intermediate circuit capacitance. This can, for example, provide a nominal voltage at a high-voltage level (>60 V), in particular a nominal voltage level in the range of several hundred volts.

The AC voltage side of the power converter circuit can be connected to at least one output of the power converter or provide at least one output of the power converter. In particular, the power converter can comprise a plurality of outputs, e.g. depending on a number of half bridges in the power converter circuit, in order to be able to drive an electrical machine that can be operated with polyphase AC voltage. For this purpose, one or more outputs of the power converter can be connected to one or more inputs of the electrical machine.

The circuit arrangement for controlling and monitoring an electrical machine comprises at least one first current sensor and a computing unit. According to one embodiment, the circuit arrangement can have at least one second current sensor, the type or measuring principle of which can differ from the first current sensor.

The at least one first current sensor and, if present, the at least one second current sensor are each configured to measure a current for driving the electrical machine (load current) at the at least one output of the power converter. In particular, the at least one second current sensor can be arranged at the same output of the power converter as the at least one first current sensor.

The first current sensor may be a wide-bandwidth sensor capable of measuring current pulses resulting from partial discharges. For example, the first current sensor can have a bandwidth of 500 MHz to 3 GHz.

The at least one first current sensor has a Rogowski coil. This is an air-core coil that generates a voltage proportional to the rate of change of a current in a current-carrying conductor when it encloses it. Due to its measuring principle, a Rogowski coil is particularly suitable for measuring rapidly changing/dynamic currents, such as those that can occur during partial discharges on an electrical machine in its supply line(s).

In particular, the second current sensor can be a current sensor that is configured to directly determine a load current of the electrical machine with a direct current and an alternating current component. In particular, the second current sensor can have a shunt or current measuring resistor, a current transformer, a GMR or TMR sensor (Giant Magneto Resistance, Tunneling Magneto Resistance) and/or a Hall effect sensor. In particular, a second current sensor can be attached to each output of the power converter and can also be used to control it. In particular, the second current sensor does not have a Rogowski coil.

The use of two different current sensors with different measuring principles increases the functional safety of the electric drive system and avoids failures due to common cause faults, i.e. failures that can be attributed to a common external or environmental factor and/or a common design or measuring element. In this way, an overall risk of dangerous failures due to random component faults can be reduced.

According to one embodiment, the at least one Rogowski coil can be integrated in a printed circuit board, in particular in a printed circuit board of the power converter. In particular, windings of the Rogowski coil can be embedded in different layers of the printed circuit board. In particular, the windings of the Rogowski coil surround the output of the power converter, which can, for example, be guided through an opening in the printed circuit board.

The computing unit can comprise an evaluation unit, which can be configured to perform a first evaluation of a current detected by means of the at least one first current sensor and to perform a second evaluation of the current detected by means of the at least one first current sensor. In particular, partial discharges on the electrical machine can be detected by means of the first evaluation of the detected current signal and their load current can be determined by means of the second evaluation of the detected current signal.

The evaluation unit can comprise at least one high-pass filter, which can be particularly configured to remove or reduce switching noise from the power converter and interference signals from the environment of the circuit arrangement from the detected current signal. A plurality of high-pass filters with different cut-off frequencies can be advantageously included in the evaluation unit, which can be used depending on the intensity of the switching noise or a total interference load of the at least one first current sensor. The at least one high-pass filter can, in particular, be an analog high-pass filter. Furthermore, the evaluation unit can comprise an amplifier, which can be an RF (high frequency) power detector, for example.

An electrical connection or signal connection between the at least one first current sensor and the evaluation unit can be configured to avoid signal distortions, in particular due to signal reflections between the evaluation unit and the at least one first current sensor. In particular, the electrical connection can be a conductor track on a printed circuit board, whereby, for example, the material of the printed circuit board as well as the material, cable routing and thickness of the conductor track can be designed accordingly.

Furthermore, the first current sensor, the electrical connection and the evaluation unit can each comprise suitable shielding against electromagnetic waves from an environment of the circuit arrangement in order to increase its immunity to interference. The shielding can, for example, comprise a Faraday cage or be a Faraday cage.

A drive system according to the disclosure comprises an electrical machine, a power converter, a DC voltage source and a circuit arrangement as described above.

A computing unit according to the disclosure is configured, in particular in terms of programming, to carry out a method according to the disclosure. The computing unit can be, for example, a control unit of a vehicle with an electric drive system. In particular, the computing unit can be or comprise the computing unit of the circuit arrangement described above.

In the method, a current is detected at at least one output of the power converter by means of the at least one first current sensor. Based on a first evaluation of the detected current, a first monitoring variable is determined to monitor the electrical machine for partial discharges. In particular, a Rogowski coil can be used as the first current sensor for this purpose.

According to one embodiment, the first evaluation can comprise filtering the detected current with at least one high-pass filter and amplifying the filtered current.

The at least one high-pass filter can be particularly configured to remove or reduce switching noise from the power converter and interference signals from the environment of the circuit arrangement from the detected current signal. It is expedient to use several high-pass filters with different cut-off frequencies, which can be used depending on the intensity of the switching noise or the total interference load of the at least one first current sensor. In particular, the at least one high-pass filter can be an analog high-pass filter.

As current pulses can have low amplitudes due to partial discharges, the filtered current signal is suitably amplified. An RF power detector can be used for this purpose, for example.

According to one embodiment, an amplitude of the current can be determined as the first monitoring variable. Amplitudes of the filtered and amplified current signal (partial discharge signal) can be used for this purpose. It is also possible for a peak voltage or a signal power of the partial discharge signal to be determined as the first monitoring variable.

According to one embodiment, a partial discharge can be detected if the determined first monitoring variable, e.g. an amplitude of the partial discharge signal, exceeds at least one predetermined limit value. For this purpose, the partial discharge signal can, for example, be forwarded to a comparator whose trigger level can be set in accordance with the predetermined limit value so that partial discharges can be detected in a predetermined frequency range of the partial discharge signal.

In particular, a first and a second limit value can be predetermined, whereby the first limit value can be lower than the second limit value.

The second limit value can be defined in such a way that there is a risk of damage to the electrical machine in the event of a partial discharge above the second limit value. In this context, a maximum number of partial discharges above the second limit value can also be predetermined from which damage can occur.

In contrast, the first limit value can be set in such a way that partial discharges above the first limit value and below the second limit value do not lead to damage to the electrical machine immediately, but only after a predetermined number of exceedances, for example.

The first and second limit values can be determined, for example, by means of endurance tests of the electric drive system, in which partial discharges are specifically generated in order to determine their effects on the electrical machine.

Furthermore, the method determines a second monitoring variable for monitoring a load current of the power converter based on a second evaluation of the detected current. In particular, the second monitoring variable can be a load current of the electrical machine, which is provided by the power converter.

According to one embodiment, the second evaluation can include filtering the detected current with at least one low-pass filter. The low-pass filter can, for example, have a maximum cut-off frequency of 5 kHz. In this way, the load current can be determined as a second monitoring variable from the broadband signal of the first current sensor. This can be used, for example, to monitor a power output by the electrical machine.

The power converter is then controlled using the determined first and second monitoring variables. In particular, the power converter can be controlled with the aid of the two monitoring variables in such a way that a desired torque and a desired speed of the electrical machine are provided and no partial discharges occur on it.

According to one embodiment, the current at the at least one output of the power converter can also be detected by a second current sensor and the second monitoring variable can also be determined based on the current detected by the second current sensor. In particular, the second current sensor can be a current sensor that is configured to directly determine a load current of the power converter with a direct current and an alternating current component. In this way, the load current of the power converter can be determined in two different ways, thereby increasing the reliability of the electric drive system.

In this context, for example, a defect in the first current sensor or the second current sensor can also be detected by comparing the second monitoring variable determined by the first and second current sensors. For example, a defect in one of the two current sensors can be detected if a difference between the second monitoring variables determined by means of the first and second current sensors exceeds a predetermined value.

According to one embodiment, a switching speed of the power converter can be reduced if a predetermined number of partial discharges are detected. In particular, the rise and fall times of switching pulses of the power converter can be extended. For example, the switching speed can be gradually reduced until no more partial discharges occur. The described reduction in the switching speed of the power converter can be carried out in particular during operation of an electric drive system.

To determine a nominal switching speed when the electric drive system is new, a maximum switching speed of the power converter at which no partial discharges occur can be determined during commissioning, for example. For this purpose, the switching speed can be continuously increased until a partial discharge or a predetermined number of partial discharges occur. Starting from this state, the nominal switching speed can then be set to a switching speed reduced by a safety margin, for example.

If a further predetermined number of partial discharges is detected during operation of the electric drive system after the switching speed of the power converter has been reduced, the power converter can be switched to a safe state according to one embodiment. The further predetermined number of partial discharges can be equal to or smaller than the predetermined number of partial discharges that leads to a reduction in the switching speed. To bring about a safe state, for example, a corresponding signal, e.g. via a CAN channel, can be sent to the vehicle control unit, which can then decide about a required action in the safety circuit of the power converter. A safe state can, for example, be a state in which the load current of the electrical machine is limited or switched off completely, for example by either closing all high-side or all low-side switches or opening all high-side and all low-side switches.

If a first and a second limit value have been defined, the switching speed of the power converter can alternatively or additionally be reduced when the first limit value is exceeded by the first monitoring variable (e.g. an amplitude of the partial discharge signal) in order to prevent further partial discharges. However, if the first monitoring variable exceeds the second limit value, the power converter can be switched to a safe state in order to prevent damage to the electrical machine.

The implementation of a method according to the disclosure in the form of a computer program or computer program product with program code for carrying out all method steps is also advantageous, as this causes particularly low costs, especially if an executing control device is still used for other tasks and is therefore available in any case. Suitable data carriers for providing the computer program are in particular magnetic, optical and electrical memories, such as hard disks, flash memories, EEPROMs, DVDs, etc. It is also possible to download a program via computer networks (Internet, Intranet, etc.).

Further advantages and embodiments of the disclosure are shown in the description and the accompanying drawing.

It is understood that the above-mentioned features and those to be explained below can be used not only in the combination indicated in each case, but also in other combinations or in a stand-alone position, without going beyond the scope of the present disclosure.

The disclosure is illustrated schematically in the drawing by means of embodiment examples and is described below with reference to the drawing.

### BRIEF DESCRIPTION OF FIGURES

Non-limiting and non-exhaustive examples are described with reference to the following figures.

FIG. 1 schematically shows an example of an electric drive system according to the disclosure.

FIGS. 2a and 2b schematically show an example of a current measuring circuit of a power converter that can be used in the drive system shown in FIG. 1.

FIGS. 3a to 3d schematically show a first design example for integrating a Rogowski coil into a printed circuit board of the current measuring circuit of the power converter shown in FIGS. 2a and 2b.

FIGS. 4a to 4d schematically show a second design example for integrating a Rogowski coil into a printed circuit board of the current measuring circuit of the power converter shown in FIGS. 2a and 2b.

FIGS. 5a to 5d schematically show a third design example for integrating a Rogowski coil into a printed circuit board of the current measuring circuit of the power converter shown in FIGS. 2a and 2b.

FIG. 6 shows a comparison of the transfer functions of the Rogowski coils shown in FIGS. 3a to 5d.

FIG. 7 shows function blocks of an evaluation unit for determining a load current and for detecting partial discharges based on a signal from one of the Rogowski coils shown in FIGS. 3a to 5d.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

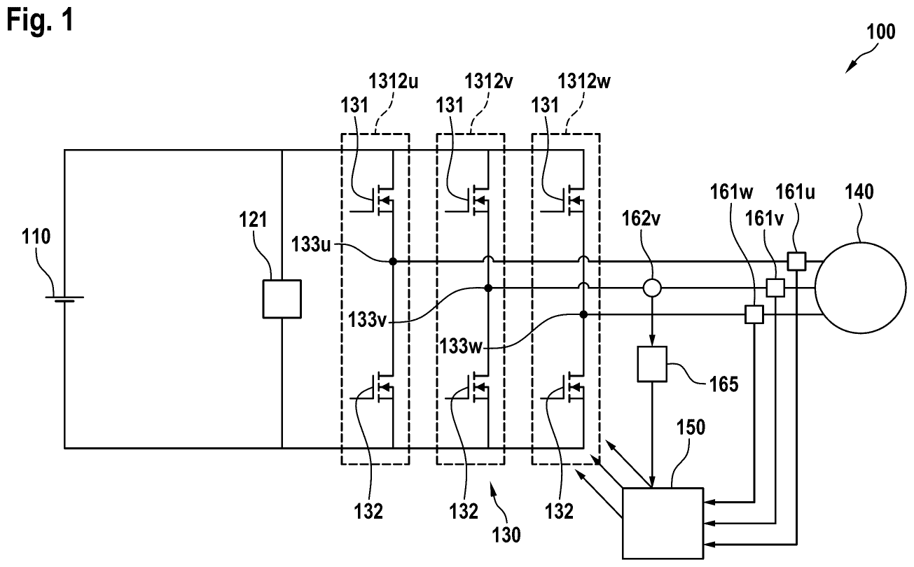

FIG. 1 shows a schematic diagram of an embodiment of an electric drive system according to the disclosure and is labelled 100. The drive system 100 can, for example, be used in a vehicle as a traction drive. The drive system 100 comprises a DC voltage source 110, a power converter 130, a multiphase electrical machine 140 and a circuit arrangement 160 for controlling and monitoring the electrical machine

The power converter 130 is used to rectify and alternate the direction of current between a DC voltage source 110, which is connected to a DC voltage side of the power converter 130, and the polyphase electrical machine 140, which is connected to an AC voltage side of the power converter 130. The DC voltage source 110 can, for example, be designed as a traction battery and the electrical machine as a traction motor of a traction drive. The traction battery can, for example, have a nominal voltage level in the range from 400 V to 800 V.

In the present case, the power converter 130 has a power converter circuit with a plurality of half bridges 1312u, 1312v, 1312w (three in this case), each of which has a high-side switch 131 and a low-side switch 132. The high-side and low-side switches 131, 132 can be designed, for example, as metal-oxide-semiconductor field-effect transistors (MOSFETs) or insulated-gate bipolar transistors (IGBTs), in particular as gallium nitride (GaN) or silicon carbide (SIC) FETs, which are operated at a high switching speed.

The DC voltage side of the power converter circuit is formed by an upper (high side) and a lower (low side) connection of the half-bridges 1312u, 1312v, 1312w and the AC voltage side is formed by center taps 133u, 133v 133w of the half-bridges 1312u, 1312v, 1312w. In the present case, the latter represent outputs 133u, 133v 133w of the power converter 130, which are connected to the electrical machine 140 by means of connecting cables in order to supply it with a three-phase load current.

FIG. 1 shows a purely exemplary three-phase electrical machine 140 and a corresponding three-phase power converter 130, i.e. a power converter with three half-bridges 1312u, 1312v, 1312w and three outputs 133u, 133v 133w, but it is understood that the electrical machine 140 and the power converter 130 may also have more or less than three phases.

In the present case, the power converter 130 also comprises an intermediate circuit capacitor 121, which is arranged between the DC voltage side of the power converter and the DC voltage source 110 and forms an intermediate circuit capacitance of the power converter 130.

A control unit 150 is provided for controlling the power converter 130, in particular for controlling the individual switches 131, 132 of the power converter 130.

A current sensor 161u, 161v, 161w, which measures the load current of the respective phase, is attached to each of the three connecting lines between the outputs 133u, 133v 133w of the power converter 130 and the electrical machine 140. In the nomenclature of the claims, these are second current sensors. The second current sensors 161u, 161v, 161w can, for example, be Hall effect sensors whose measurement signals are sent to the control unit 150 (indicated by the arrows between the second current sensors 161u, 161v, 161w and the control unit 150), which uses them, for example, to control the power converter 130 (indicated by the arrows emanating from the control unit 150 in the direction of the power converter 130). The second current sensors 161u, 161v, 161w can also be arranged directly at the outputs 133u, 133v 133w.

In addition, a current sensor 162v, which is connected in series with the second current sensor 161v, is arranged on a connecting line between the output 133v of the power converter 130 and the electrical machine 140. In the nomenclature of the claims, this is the first current sensor. The measurement signals of the first current sensor 162v are sent to an evaluation unit 165 (indicated by the arrows between the first current sensor 162v and the evaluation unit 165).

The first current sensor 162v can also be arranged directly at the output 133v of the power converter 130 or integrated there into a printed circuit board of the power converter 130. In particular, the first current sensor 162v can be a Rogowski coil, which has a large bandwidth, or it can have a Rogowski coil. It is also possible that more than one first current sensor is arranged on a connecting line or an output 133u, 133v, 133w of the power converter.

In the present case, the evaluation unit 165 is designed as a separate computing unit that is connected to the control unit 150 (indicated by the arrow between the evaluation unit 165 and the control unit 150). It is also possible for the evaluation unit 165 to be integrated directly into the control unit 150. Alternatively, the evaluation unit 165 can be integrated in the power converter 130. The power converter 130, the evaluation unit 165 and the control unit 150 can also form a structural unit or device that can be arranged in a vehicle between the traction motor 140 and the traction battery 110, for example.

The evaluation unit 165 can be configured to detect partial discharges on the electrical machine 140 based on a current signal measured by the first current sensor 162v using a first monitoring variable and/or to determine a load current as a second monitoring variable in the corresponding phase of the electrical machine 140.

To detect partial discharges, the evaluation unit 165 can contain at least one high-pass filter, which can be particularly configured to remove or reduce switching noise from the power converter 130 and interference signals from the environment of the electric drive unit 100 from the detected current signal. Expediently, several high-pass filters with different cut-off frequencies can be contained in the evaluation unit 165, which can be used depending on an intensity of the switching noise or a total interference load of the first current sensor. The at least one high-pass filter may in particular be an analog high-pass filter. Furthermore, the evaluation unit 165 can comprise an amplifier, which can be an RF power detector, for example.

The filtered and amplified current signal (partial discharge signal) can then be sent to the control unit 150, where it can be compared with a predetermined limit value to detect partial discharges. In the process, amplitudes of the partial discharge signal can be determined as the first monitoring variable, and a partial discharge can be detected if the determined first monitoring variable exceeds the predetermined limit value. For this purpose, the partial discharge signal can, for example, be forwarded to a comparator in the control unit 150, the trigger level of which can be set according to the predetermined limit value so that partial discharges can be detected in a predetermined frequency range of the partial discharge signal. It is also possible for the partial discharges to be detected in the evaluation unit 165. A first and a second limit value can also be predetermined, whereby the first limit value can be lower than the second limit value, so that weak partial discharges can be detected by means of the first limit value and strong partial discharges can be detected by means of the second limit value, for example. The limit values can, for example, be determined on the basis of endurance tests of the electric drive system 100, in the course of which partial discharges are specifically generated in order to determine their effects on the electrical machine 140.

In order to determine the load current in the phase of the electrical machine 140 as a second monitoring variable from the broadband measurement signal of the Rogowski coil, the evaluation unit 165 can also comprise at least one low-pass filter. The low-pass filter can, for example, have a cut-off frequency of at most 5 kHz in order to remove high-frequency interference from the measurement signal. The low-pass filtered measurement signal can then also be sent from the evaluation unit to the control unit, where it can be used, for example, to check the plausibility of the measurement signal from the second current sensor 161v on the same connection line. In this way, the load current in the corresponding phase of the electrical machine is determined by means of two different current sensors 161v, 162v, which can increase the functional safety of the electrical drive system 100.

The control unit 150 can then, based on the partial discharges and the load current determined, control the power converter in such a way that a desired output of the electrical machine is provided and no partial discharges occur.

When partial discharges are detected, the control unit 150 can in particular reduce a switching speed of the power converter 130 by increasing the rise and fall time of the switching process (slowing down the switching speed), e.g. via SPI communication or in some gate drivers by adjusting the gate driver strength via dedicated pins (not shown in the figure). This can be done, for example, when a predetermined number of partial discharges have been detected by the control unit 150 or the first evaluation unit 165. The switching speed can be reduced step by step, for example, until no more partial discharges occur. If a further predetermined number of partial discharges is detected after the switching speed of the power converter 130 has been reduced, the control device 150 can switch the power converter 130 to a safe state. A safe state can, for example, be a state in which the load current of the electrical machine 140 is limited or switched off completely. In this way, damage to the insulation of the electrical machine 140 due to partial discharges can be avoided.

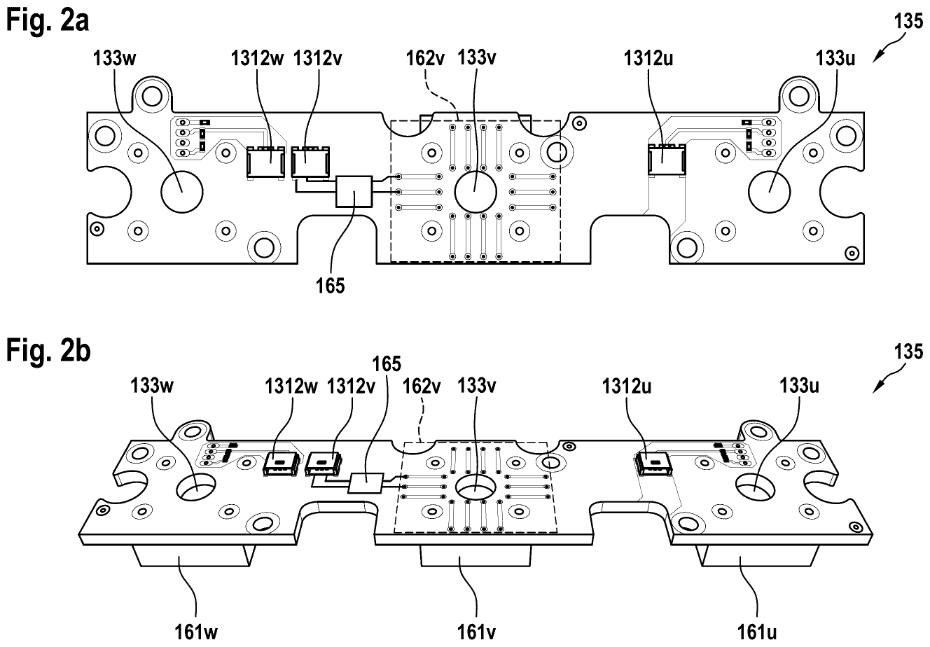

FIGS. 2a and 2b schematically show an embodiment of a current measuring circuit of a power converter that can be used in the drive system shown in FIG. 1. The current measurement circuit (circuit arrangement) comprises a printed circuit board 135 on which the three half bridges 1312u, 1312v, 1312w are mounted as integrated circuits. Outputs 133u, 133v, 133w of the power converter 130, which are connected to the AC side of the half bridges 1312u, 1312v, 1312w (not shown), can also be recognized on the printed circuit board. A second current sensor 161u, 161v, 161w is attached to the rear of the printed circuit board 135 at each of the outputs 133u, 133v, 133w (see FIG. 2b). Adjacent to the second current sensors 161u, 161v, 161w, there are connections not described in more detail, to which connection lines to the electrical machine 140 can be connected. The first current sensor 162v is attached to the output 133v and has a Rogowski coil which is integrated into the printed circuit board 135. Analogous to FIG. 1, the first current sensor 162v is connected to the evaluation unit 165. In the present case, the evaluation unit 165 is connected directly to the half-bridge 1312v, so that its output variables flow directly into the control of the half-bridge. It is also possible that a first current sensor with Rogowski coil is arranged at more than one output 133u, 133v, 133w, the measurement signals of which are sent to the evaluation unit 165.

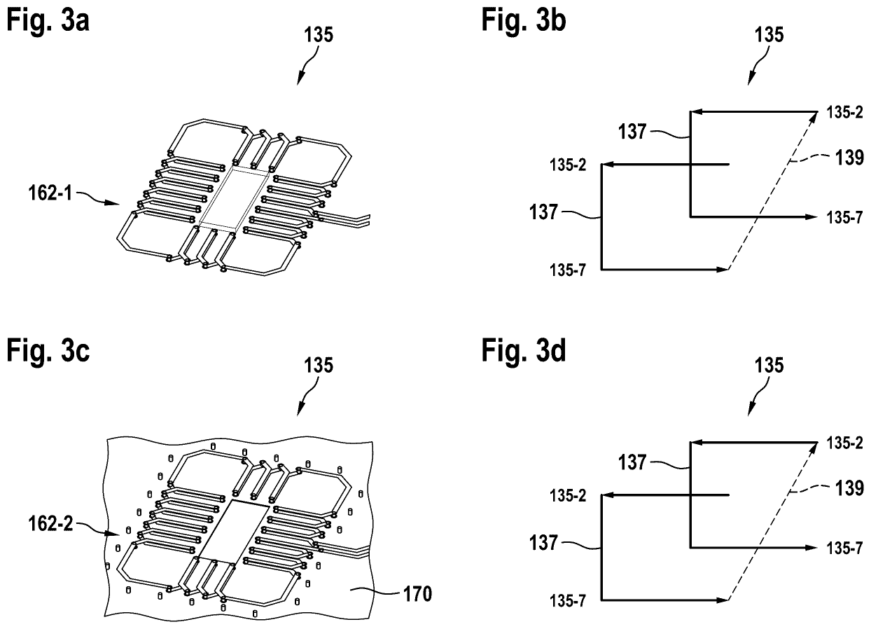

FIGS. 3a to 3d schematically show a first embodiment example for integrating a Rogowski coil 162-1, 162-2 into the printed circuit board 135 of the current measuring circuit of the power converter 130 shown in FIGS. 2a and 2b. In particular, FIG. 3a shows a printed circuit board 135 with at least two, for example eight layers, into which the Rogowski coil 162-1 is integrated according to the first embodiment example, and FIG. 3b shows the corresponding winding scheme. A Rogowski coil 162-2 shown in FIG. 3c differs from that shown in FIG. 3a only in that it is provided with a shielding layer 170. In particular, the Rogowski coil 162-2 has the same winding scheme as the Rogowski coil 162-1 in FIG. 3a (see FIG. 3d). In order to ground the shielding layer 170 of the Rogowski coil 162-2 shown in FIG. 3c if required, a plurality of vias are provided around it on the printed circuit board 135.

According to the winding scheme shown in FIGS. 3b and 3d, the printed circuit board may have eight layers and the Rogowski coil 162-1, 162-2 is formed in a second and a seventh layer 135-2, 135-7 of the printed circuit board 135, and the two different layers are interconnected by vias 137. The individual windings are connected to each other by a lead 139. This type of winding offers a simple way of inserting a Rogowski coil into a printed circuit board.

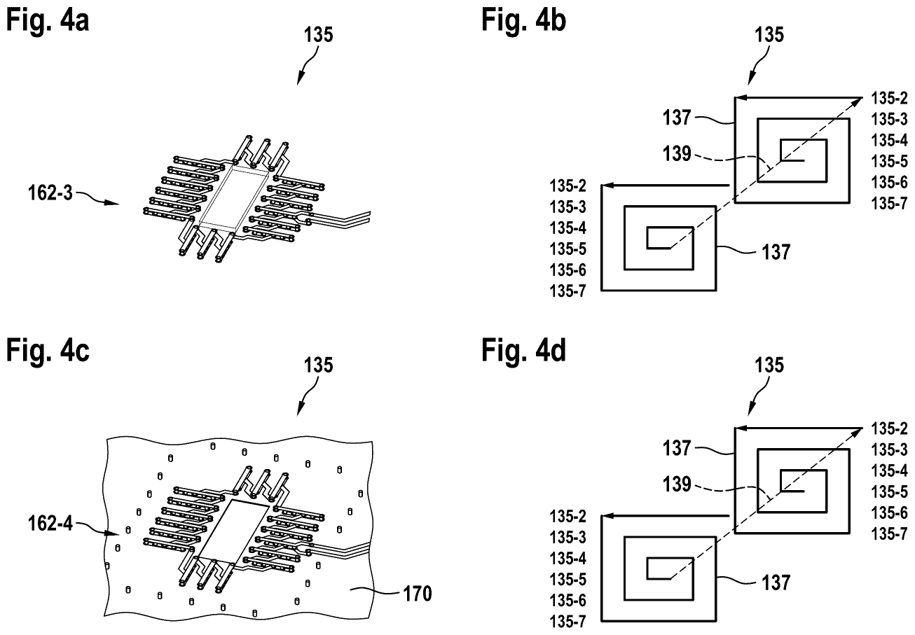

FIGS. 4a to 4d schematically show a second embodiment example for integrating a Rogowski coil 162-3, 162-4 into a printed circuit board of the current measuring circuit of the power converter shown in FIGS. 2a and 2b. FIG. 4a shows a printed circuit board 135 with at least six, for example eight layers, into which a Rogowski coil 162-3 is integrated according to the second embodiment example, and FIG. 4b shows the corresponding winding diagram. A Rogowski coil 162-4 shown in FIG. 4c differs from that shown in FIG. 4a only in that it is provided with a shielding layer 170. In particular, the Rogowski coil 162-4 has the same winding scheme as the Rogowski coil 162-3 in FIG. 4a (see FIG. 4d). In order to ground the shielding layer 170 of the Rogowski coil 162-4 shown in FIG. 4c if required, a plurality of vias are provided around it on the printed circuit board 135.

According to the winding diagram shown in FIGS. 4b and 4d, the Rogowski coil 162-3, 162-4 is formed in six layers 135-2 to 135-7 of the printed circuit board 135. For this purpose, a first via 137 extends from the second layer 135-2 to the seventh layer 135-7, a second via 137 extends from the seventh layer 135-7 to the third layer 135-3, a third via 137 extends from the third layer 135-3 to the sixth layer 135-6, a fourth via 137 extends from the sixth layer 135-6 to the fourth layer 135-4 and a fifth via 137 extends from the fourth layer 135-4 to the fifth layer 135-5. In this way, the winding forms a spiral in the cross-section of the printed circuit board 135. The connection between the individual windings is again made via a lead 139. By using a plurality of layers of the printed circuit board 135, a number of windings of the Rogowski coil 162 can be increased and thus its measurement signal can be amplified. This can improve the detection of partial discharges by means of the Rogowski coil 162.

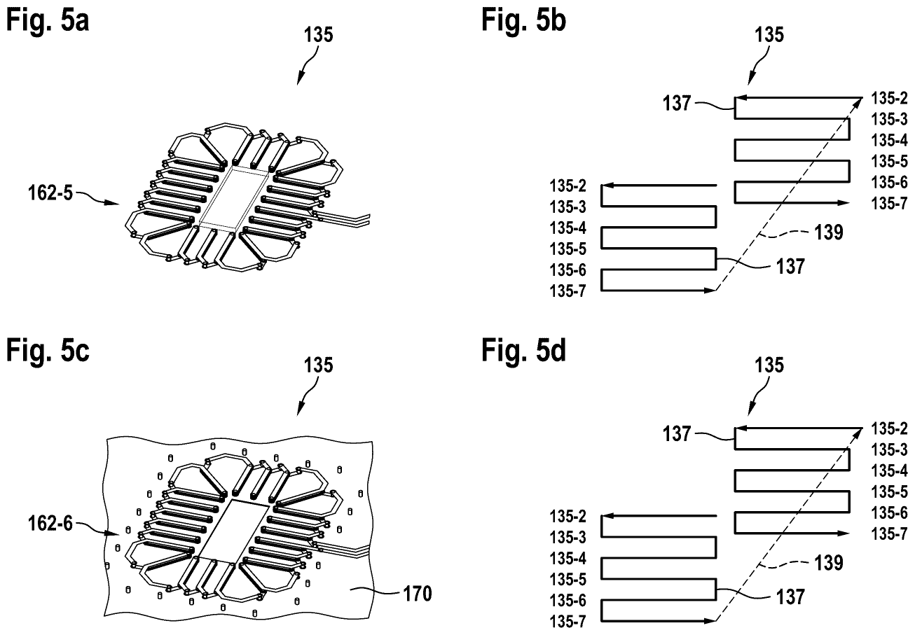

FIGS. 5a to 5d schematically show a third embodiment example for integrating a Rogowski coil 162-5, 162-6 into a printed circuit board 135 of the current measuring circuit of the power converter 130 shown in FIGS. 2a and 2b. FIG. 5a shows a printed circuit board 135 with at least six, for example eight layers, into which a Rogowski coil 162-5 is integrated according to the third embodiment example, and FIG. 5b shows the corresponding winding diagram. A Rogowski coil 162-6 shown in FIG. 5c differs from that shown in FIG. 5a only in that it is provided with a shielding layer 170. In particular, the Rogowski coil 162-6 has the same winding scheme as the Rogowski coil 162-5 in FIG. 5a (see FIG. 5d). In order to ground the shielding layer 170 of the Rogowski coil 162-6 shown in FIG. 5c if necessary, a plurality of vias are provided around it on the printed circuit board 135.

In particular, the winding scheme shown in FIGS. 5b and 5d is an alternative to the winding scheme shown in FIGS. 4b and 4d when all layers between the second layer and the seventh layer are used to form the Rogowski coil. In the present case, a first via 137 extends from the second layer 135-2 to the third layer 135-3, a second via 137 extends from the third layer 135-3 to the fourth layer 135-4, a third via 137 extends from the fourth layer 135-4 to the fifth layer 135-5, a fourth via 137 extends from the fifth layer 135-5 to the sixth layer 135-6 and a fifth via extends from the sixth layer 135-6 to the seventh layer 135-7. In this way, the winding forms a snake or meander with respect to the cross-section of the printed circuit board 135. The connection between the individual windings is again made by the lead 139. By using a plurality of layers of the printed circuit board 135, a number of windings of the Rogowski coil 162 can be increased and thus its measurement signal can be amplified. This can improve the detection of partial discharges by means of the Rogowski coil 162.

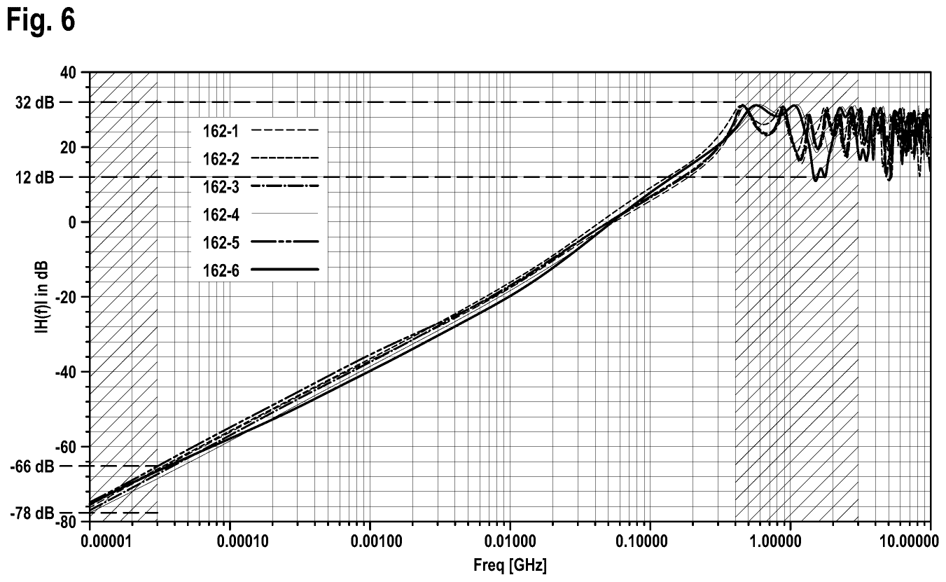

FIG. 6 shows a comparison of the transfer functions of the Rogowski coils 162-1 to 162-6 shown in FIGS. 3a to 5d. The transfer functions were simulated in a 50Ω system using the following equation.

$$H ( f ) = \frac{{V}_{out}}{{I}_{i n}}$$

They characterize the dependence of the current flowing through the phase bar and the induced voltage in the Rogowski coil. All embodiments 162-1 to 162-6 of the Rogowski coil have similar transfer functions up to about 400 MHz. Above this frequency, where the frequency range of interest for the detection of partial discharges begins, the different designs show different behavior. In general, adding a shield 170 around the Rogowski coil shifts the natural resonant frequency to higher frequencies. This can be seen, for example, when comparing designs 162-3 and 162-4 or 162-5 and 162-6. The wide range of amplification (12 dB-32 dB) between 400 MHz and 3 GHz in the various designs does not limit the performance of the Rogowski coil, but must be considered in the process of developing the circuit for detecting partial discharges.

For phase current measurements, the relevant range of which is generally between 10 kHz and 30 kHz, all embodiments 162-1 to 162-6 of the Rogowski coil show an attenuation of between 66 dB and 78 dB. Using a decibel conversion formula, this corresponds to an induced voltage of approximately 12 mV to 50 mV (for 100 A phase current) or 120 μV to 500 μV (for 1 A phase current). A high-resolution measuring circuit is required to measure the phase currents accurately. Alternatively, the number of turns in the Rogowski coil can be increased to increase the induced voltage and enable better measurement of the phase current.

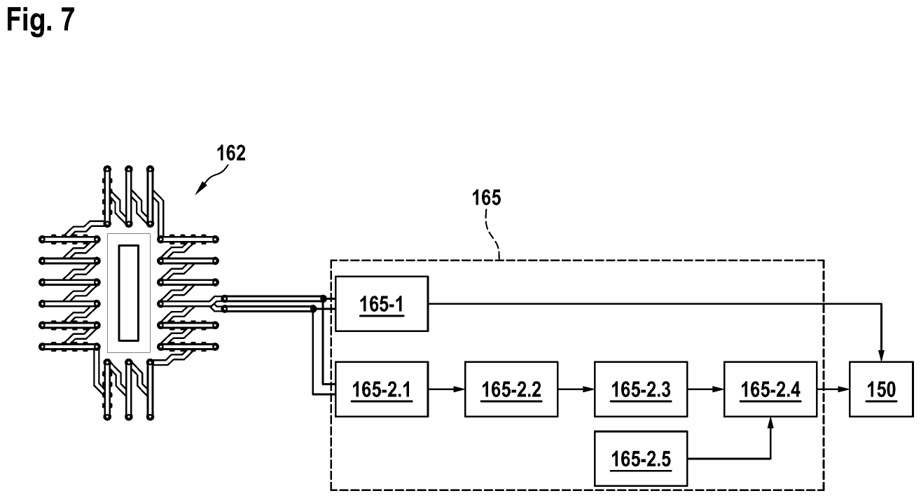

FIG. 7 shows functional blocks of an evaluation unit 165 for determining a load current and for detecting partial discharges based on a signal from one of the Rogowski coils 162 shown in FIGS. 3a to 5d.

The evaluation unit 165 is designed to measure the load current while simultaneously utilizing the Rogowski coil 162 to detect partial discharges. Two amplifier circuits with different amplifications are used to attenuate and amplify the transfer function (see FIG. 6).

In particular, the function block 165-1 comprises a low-pass filter and an amplifier for determining the load current based on a signal from the Rogowski coil 162. This function block makes it possible to provide a second current signal based on a different measurement principle, thereby increasing the functional reliability of the electric drive system and avoiding failures due to common cause faults.

In order to detect a partial discharge, the signal from the Rogowski coil 162 is first fed into a high-pass filter 165-2.1, from which it is forwarded to an amplifier 165-2.2. In the present case, the amplified signal is subsequently fed into a voltage or power detector 165-2.3, in which a peak voltage or a signal power is determined. The determined peak voltage or signal power is then forwarded to a comparator 165-2.4, in which it is compared with a limit value stored in a memory 165-2.5. It is also possible that a large number of limit values are stored in the memory 165-2.5. By comparing the peak voltage or the signal power with one or more limit values, it is possible to determine whether a partial discharge is present and/or whether the level of the partial discharge exceeds a safe level.

The measurement signals are sent to the control unit 150, which uses them to control the power converter 130, for example.

1. A method for controlling and monitoring an electrical machine (140) powered by a power converter (130), comprising the steps of:
detecting a current, in particular an alternating current, at at least one output of the power converter (130) by means of at least one first current sensor (162v), wherein the at least one first current sensor (162v) has a Rogowski coil (162; 162-1 to 162-6);
determining a first monitoring variable for monitoring the electrical machine (140) for partial discharges based on a first evaluation of the detected current;
determining a second monitoring variable for monitoring a load current of the power converter (130) based on a second evaluation of the detected current; and
controlling the power converter (130) using the determined first monitoring variable and the determined second monitoring variable.

2. The method for claim 1, wherein the first evaluation of the detected current comprises:
filtering the detected current with at least one high-pass filter; and
in particular amplifying the filtered current.

3. The method according to claim 1, comprising:
determining an amplitude of the current as the first monitoring variable.

4. The method according to claim 1, comprising:
detecting a partial discharge when the determined first monitoring variable exceeds at least one predetermined limit value.

5. The method according to claim 1, comprising:
reducing a switching speed of the power converter (130) when a predetermined number of partial discharges is detected.

6. The method according to claim 5, comprising:
switching the power converter (130) to a safe state if a further predetermined number of partial discharges is detected after the reduction of the switching speed of the power converter (130).

7. The method according to claim 1, comprising:
predetermining a first and a second limit value,
reducing a switching speed of the power converter (130) when the first monitoring variable exceeds the first predetermined limit value, and
switching the power converter (130) to a safe state when the first monitoring variable exceeds the second predetermined limit value.

8. The method according to claim 1, wherein the second evaluation comprises filtering the detected current with at least one low-pass filter.

9. The method according to claim 1, comprising:
additionally detecting the current at the at least one output (133u, 133v, 133w) of the power converter (130) detected by means of at least one second current sensor (161u, 161v, 161w), the measuring principle of which differs from the first current sensor (162v), and
additionally determining the second monitoring variable for monitoring the power converter (130) based on the current detected by means of the at least one second current sensor (161u, 161v, 161w).

10. A computing unit comprising a processor configured to perform the method according to claim 1.

11. A circuit arrangement for controlling and monitoring an electrical machine (140) which is powered by a power converter (130), comprising at least one first current sensor (162v) and the computing unit according to claim 10, wherein the at least one first current sensor (162v) has a Rogowski coil (162; 162-1 to 162-6).

12. The circuit arrangement according to claim 11, wherein the at least one Rogowski coil (162; 162-1 to 162-6) is integrated in a printed circuit board (135), in particular in a printed circuit board (135) of the power converter (130).

13. The circuit arrangement according to claim 11, further comprising at least one second current sensor (161u, 161v, 161w), the measuring principle of which differs from the first current sensor (162v).

14. A drive system (100) comprising an electrical machine (140), a power converter (130), a DC voltage source (110) and the circuit arrangement according to claim 11.
